(19) United States
(12) Patent Application Publication
(10) Pub. No.: US 2005/0272012 A1
(43) Pub. Date: Dec. 8, 2005

(54) Method and apparatus for thermal coding of colors

(75) Inventors: Sean A. Logan, Peoria, IL (US); Keith Hundley, Forsyth, IL (US)

Correspondence Address: HUSCH & EPPENBERGER, LLC, 190 CARONDELET PLAZA, SUITE 600, ST. LOUIS, MO, 63105-3441, US

(73) Assignee: Sean Logan, Peoria, IL (US)

(21) Appl. No.: 11/107,170

(22) Filed: Apr. 15, 2005

Related U.S. Application Data
(60) Provisional application No. 60/562,676, filed on Apr. 15, 2004.

(51) Int. Cl. G09B 21/00

(52) U.S. Cl. 434/112

(57) ABSTRACT

A method and apparatus of thermally coding a color-coded object is disclosed. The method includes the steps of: dividing the object into any number of zones based on the use of at least one color in the object; assigning each of said zones a desired temperature; thermally insulating each of said zones from one another; providing at least one heat source for each of said zones; providing at least one temperature sensor with a desired temperature set point for each of said zones; and controlling said at least one heat source to maintain said desired temperature within each of said zones.

### CROSS REFERENCE TO RELATED APPLICATIONS

This application claims the benefit of U.S. Provisional Application No. 60/562,676 filed on Apr. 15, 2004.

### BACKGROUND OF THE INVENTION

1. Field of the Invention

The present invention relates generally to accommodations for the visually impaired and, more particularly, to a method and apparatus designed to enable the visually impaired to perceive variations in color.

Related Art

The visually-impaired live in a world without color. For those individuals born with a visual impairment, even the concept of “color” may be difficult or impossible to grasp. This makes understanding any concept incorporating color, from experiencing an artistic work to determining the difference between a green apple and a red apple, extraordinarily difficult for these individuals. To date, nothing has been available to these individuals that offered the chance to experience and understand color and variation of color. However, the visually-impaired do have and rely on other senses, in particular, the sense of touch. Many visually-impaired individuals exhibit an enhanced tactile sense, due in large part to their increased reliance on this sense.

Therefore, it would be desirable to provide a method for the visually-impaired to experience and relate to color and variations in color in the world around them through tactile means.

The present invention is directed to overcoming one or more of the problems set forth above.

### SUMMARY OF THE INVENTION

An aspect of the present invention is to provide a method of translating color and, in particular, variations in color into non-visual expression.

Another aspect of the present invention is to provide a method and apparatus to enable the visually impaired to experience a visually based artistic work or other color-dependant object.

In accordance with the above aspects of the invention, there is provided a method of thermally coding a color-based object that includes the steps of dividing the object into any number of color/temperature zones based on the use of color in the object; each color/temperature zone being assigned a desired temperature; thermally insulating each of the color/temperature zones from one another; providing at least one heat source for each of the color/temperature zones; providing at least one control mechanism with a desired temperature set point for each of the color/temperature zones; and controlling each heat source to maintain the temperature of its respective color/temperature zone at the desired temperature.

There is also provided an associated apparatus for thermally coding a color-based object comprising a frame supporting the object and separating the object into any number of color/temperature zones; a heat source for each of the color/temperature zones; and a control mechanism for each of the color/temperature zones.

Thus, in furtherance of the above goals and advantages, the present invention is, briefly, an apparatus for thermally coding an artistic work. The apparatus includes a box, the box having a plurality of side panels and a backing plate, and the artistic work mounted to a front end portion of the box; a plurality of barriers, the plurality of barriers defining at least one zone; at least one heat source operatively connected to the box for heating the at least one zone; and at least one control mechanism electrically connected to the at least one heat source, the at least one control mechanism adapted to maintain a temperature within the at least one zone.

These aspects are merely illustrative of the various aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a side schematic view of an apparatus for thermally coding an object according to one embodiment of the present invention.

FIG. 2 is a side schematic view of a frame according to one embodiment of the present invention.

FIG. 3 is an electrical schematic for an apparatus for thermally coding an object.

FIG. 4 is a position schematic illustrating color/temperature zones and insulation barriers for an apparatus for thermally coding an object.

FIG. 5 is a position schematic illustrating placement of heat sources for an apparatus for thermally coding an object.

FIG. 6 is a position schematic illustrating placement of temperature sensors for an apparatus for thermally coding an object.

FIG. 7 is a side schematic view of an apparatus for thermally coding an object according to a second embodiment of the present invention.

FIG. 8 is a top schematic view of a fibrous heating panel according to one embodiment of the present invention.

### DETAILED DESCRIPTION OF THE PREFERRED EMBODIMENTS

In the following detailed description, numerous specific details are set forth in order to provide a thorough understanding of the invention. However, it will be understood by those skilled in the art that the present invention may be practiced without these specific details. For example, well-known methods, procedures, and components have not been described in detail so as not to obscure the present invention.

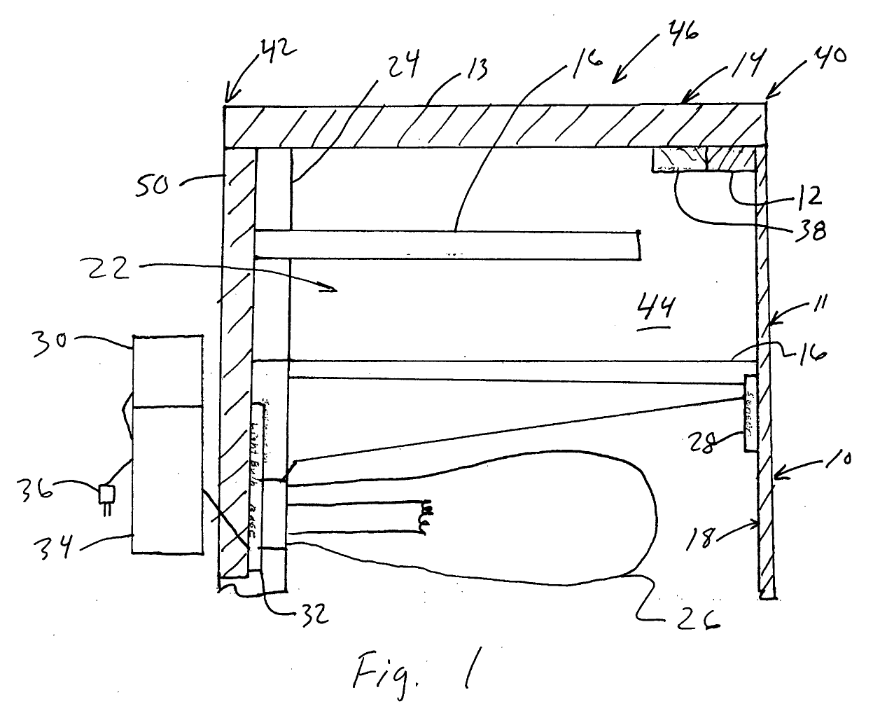

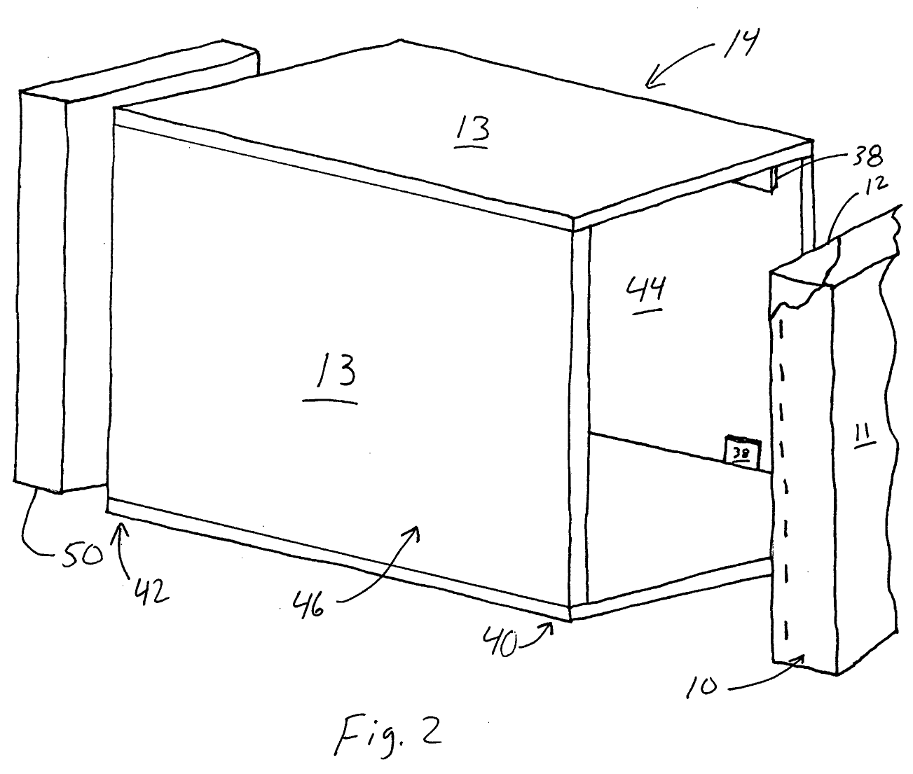

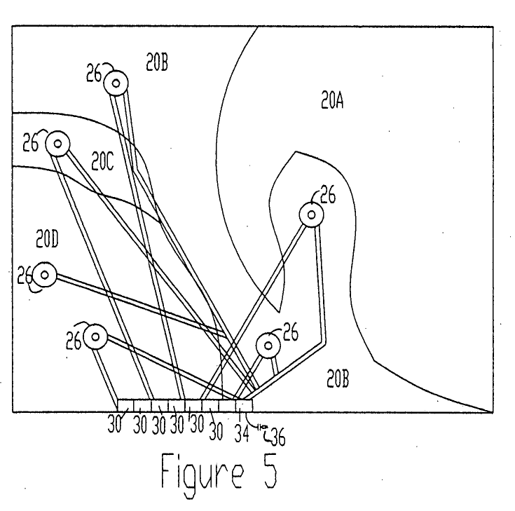

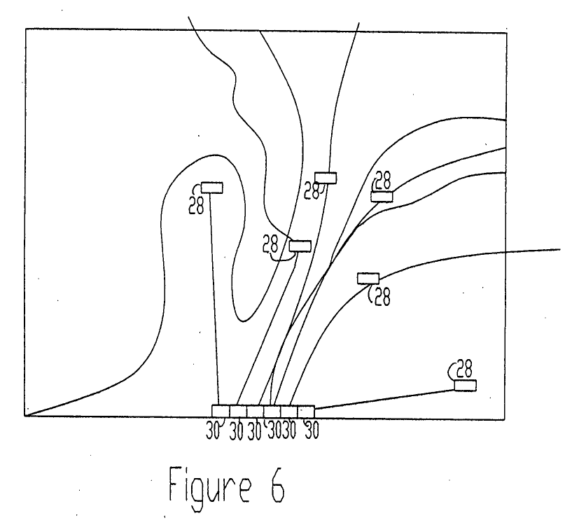

FIGS. 1-6 illustrate various components of a thermally coded object; in the illustrated case, an artistic work. In the embodiment illustrated, the artistic work is a two-dimensional painting rendered on a canvas 10. However, as will be readily appreciated by those of skill in the art, the disclosed method can be applied to other two-dimensional art forms in any medium, including tracings, etchings, collages, portraits, etc., as well as three-dimensional art works. The canvas 10 is mounted on a standard canvas strainer 12 that gently stretches and supports the canvas 10 in a known manner. The canvas 10 and strainer 12 are mounted to a frame 14. The frame 14 is a device that provides a structure to place the artistic work in close proximity to components which are used to thermally code the artistic work. The frame 14 has a depth suitable to house the components of the apparatus described in more detail below. In the embodiment depicted in FIG. 2, the frame 14 is a box that has side panels 13. The frame 14 may be made from wood, metal, plastic, fiberglass or any other suitable rigid material.

The frame 14 has a front end portion 40 and a rear end portion 42. A backing plate 50 is attached to the frame 14. In the embodiment depicted in FIG. 1, the canvas 10 and canvas strainer 12 are mounted to the front end portion 40, and the backing plate 50 is mounted to the rear end portion 42. However, those skilled in the art would understand that these positions may be reversed. The frame 14 also includes an interior 44 and an exterior 46. As an example, stops 38 may be mounted to the interior 44 of the frame 14 to locate the canvas 10 and canvas strainer 12 relative to the frame 14. In the embodiment depicted in FIG. 2, stops 38 are mounted to the interior 44 in two places. While two stops 38 are shown in the depicted embodiment, any number of stops 38 may be used. What is significant is that the stops 38 locate the canvas 10 relative to the frame 14.

Optionally, a layer of conductive material 18 is applied to the rear of the canvas 10. The layer of conductive material 18 enhances the transfer of heat through the canvas 10 while also serving to protect the canvas 10 from excess heat. In the depicted embodiments, the conductive material 18 is an aluminum foil tape.

Barriers 22 are formed within the box 14 to provide perimeters of color/temperature zones 20. In the embodiment depicted in FIG. 1, the barriers 22 are formed by insulation supported by supports 16. However, other devices may be used to separate the color/temperature zones 20. For example, the barriers 22 may be made of expanded synthetic resinous material (such as foam), cardboard, or tubing. The barriers 22 thermally isolate one color/temperature zone 20 from the next and help ensure that the appropriate temperature differential between the color/temperature zones 20 is maintained.

The supports 16 extend from the backing plate 50 to an area near the canvas 10. In some embodiments, the supports 16 may extend completely to the canvas 10. In the embodiments shown, the supports 16 are wooden dowel rods. However, the supports 16 can also take the form of solid or partial walls. The box 14 is further insulated with a layer of insulation 24 mounted on the backing of the box 14. Preferably, the layer of insulation 24 is connected with the barriers 22 to completely encase each color/temperature zone 20.

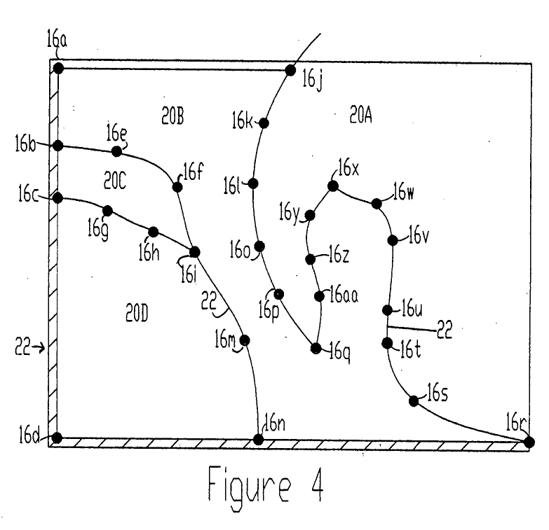

As illustrated in FIG. 4, a number of color/temperature zones 20 are identified and arranged in relation to the canvas 10. The color/temperature zones 20 correlate to regions of different colors used on the canvas 10. The creation of these color/temperature zones 20, which correspond and vary according to the colors of the artistic work, provides a temperature differential which the visually impaired can feel. These temperature differentials allow a visually impaired individual to “feel” the variation in color as they run their extremities across the front surface of the canvas 10, thereby allowing the individual to experience the artistic work and gain some measure of its appearance. In a particular preferred embodiment, the temperature differentials correlate in a logical manner to the colors used in the work. For example, brighter colors in the work are assigned higher temperatures while darker colors are assigned lower temperatures. This allows a visually impaired individual to identify not only basic differences in color but also provides a basis for her or him to begin to associate particular temperatures with certain colors and “see” the work. In addition to elevated temperatures, room temperature and cooler temperatures may be incorporated into the color/temperature zone layout.

Each of the color/temperature zones 20, except those zones in which the desired temperature is room temperature or lower, includes a heat source 26 and a control mechanism. FIGS. 4-6 illustrate a non-limiting example of the separation of an artistic work into several different color/temperature zones 20, each color/temperature zone 20 having a corresponding heat source 26 and the control mechanism.

In the embodiment depicted in FIG. 1, the control mechanism includes a temperature sensor 28 and a relay 30. Each temperature sensor 28 is set to the desired temperature for that particular color/temperature zone 20. In a preferred embodiment, the heat source 26 is mounted to the backing of the box 14, while the temperature sensor 28 is mounted at the rear surface of the layer of conductive material 18 by any suitable means, including glue, tape, hook and loop fasteners, etc. This positioning of the temperature sensor 28 produces increase accuracy in measuring the actual temperature in the color/temperature zone at the surface of the canvas 10. While the embodiments shown utilize a single temperature sensor 28 in each color/temperature zone 20, it is within the scope of the invention to use a plurality of temperature sensors spaced around each color/temperature zone to ensure evenness of temperature across the entirety of each zone. However, when a single temperature sensor 28 is used, it should be positioned as closely to the center of the color/temperature zone 20 as possible.

The heat source 26 and temperature sensor 28 are connected to a power source via the relay 30. Each color/temperature zone 20 is provided with a separate relay 30 to control that particular zone 20. The relay 30 controls the flow of power to the heat source 26 according to a signal sent by the temperature sensor 28. When the target temperature is met, the relay 30 opens the circuit transmitting power to the heat source 26. When the temperature falls below the target temperature, the relay 30 closes the circuit, thereby providing power to the heat source 26.

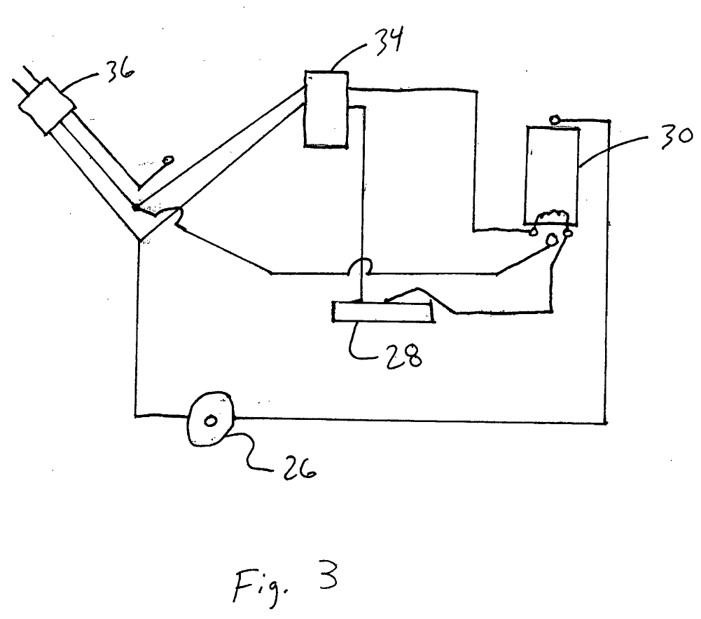

In the non-limiting example shown in FIG. 3, a normally-open relay 30 is connected with the temperature sensor 28 and heat source 26. When the temperature as measured by the temperature sensor 28 falls below the set point temperature, the temperature sensor 28 closes the normally-open pole of the relay 30, thereby completing the circuit between the heat source 26 and the power source and turning the heat source on. When the temperature of the zone 20 matches the set point temperature, the temperature sensor 28 allows the normally-open pole of the relay 30 to open, thereby disconnecting power to the heat source. This non-limiting example is providing for illustration. Various wiring methods and mechanisms, as well as electronic equivalents, are known in the art and are suitable for incorporation into the present invention.

In an alternative embodiment, the temperature sensor 28 may be eliminated. In this embodiment, the control mechanism includes only the relay 30. The relay 30 is a timer relay in this alternative embodiment. In other words, the relay 30 includes a timer such that the relay 30 cycles on and off over time. As an example, the relay 30 may open the circuit transmitting power to the heat source 26 for about five minutes and then the relay 30 closes the circuit for about five minutes, thereby providing power to the heat source 26. In this manner, the heat source 26 can cycle on and off to maintain a desired temperature in the respective color/temperature zone 20.

### NON-LIMITING EXAMPLES

FIGS. 1-6 provide a non-limiting example of an apparatus for thermal coding of an artistic work. The apparatus utilizes standard long-life light bulbs as the heat source 26 in each color/temperature zone 20. The light bulbs are connected to fixtures 32 that are attached to the backing of the box 14. As an example, the temperature sensors 28 in each color/temperature zone 20 may be standard mercury switches. The powered components of the color/temperature zones 20 are all connected to a transformer 34 that is, in turn, connected to a standard electrical wall outlet via plug 36. Specifically, standard long burning light bulbs are utilized in the generally flat fixtures 30 that have been attached to the backing plate 50:
two fixtures into the bottom, left corner (88° F. zone, generally indicated by reference 20D);
one fixture above that (80° F. zone, generally indicated by reference 20C);
one in top, left corner (74° F. zone, generally indicated by reference 20B);
one fixture in the “finger” in the center of the painting (74° F. zone, generally indicated by reference 20B);
one fixture in the base of the “finger” (74° F. zone, generally indicated by reference 20B); and
no fixture in the upper right hand corner (Room temperature zone, generally indicated by reference 20A).

The positioning of the light fixtures illustrated in the figures is purely dependent on the painting to be thermally coded and are not intended to be limiting in any manner. The fixtures 32 are connected to a standard 110v electrical outlet via the transformer 34 by 14-gauge wiring. The transformer 34 converts the voltage to 24v. Each of the 24v relays 30 are connected with the transformer 34 via 18-gauge thermostat wire. Accutherm mercury sensors 28 in each color/temperature zone 20 are then wired to the relay 30 and taped into position on the rear of the canvas using foil tape. Once again, this is a non-limiting example of one apparatus suitable for accomplishing the present invention. The use of all known and hereafter discovered temperature sensing devices, relays, controllable heat sources, and their electronic equivalents is within the scope of the present invention.

With respect to the structural construction of the illustrated apparatus in FIGS. 1-6, the inner backing of the box/frame 14 is covered with a 1.25 inch fiberglass foam board insulation layer with a top layer of aluminum reinforcement, acting as both an insulating and reflective device. A series of dowel rods are placed and glued into holes outlining the shapes of color/temperature zones. Standard 3-inch pink fiberglass insulation is interwoven between the “pegs” and then stitched into place into the foam/aluminum backing. In the embodiment depicted in FIG. 4, the “pegs” are indicated by reference numerals 16a-16aa. The sides of the color/temperature zones are also insulated and stapled into place.

The canvas is slid into the box/frame, a drawstring is attached to the rear of the canvas strainer and pulled through a hole at top in order to insure secure placement. Maintenance bungees are secured to the inner box/frame and strainer via screw eyes in order to hold canvas to box/frame to maintain bulbs, sensors, etc. Heavy-duty screw-eyes are placed on the rear of the box, and mirror-hanging wire is used for gallery hanging purposes.

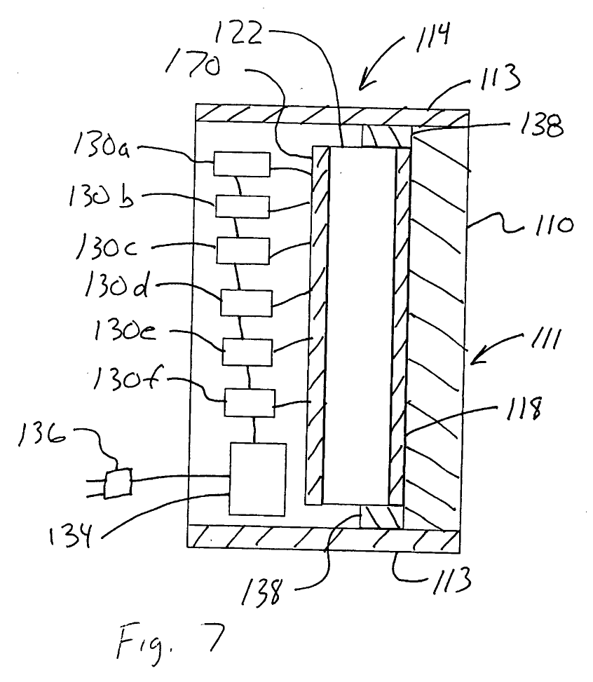

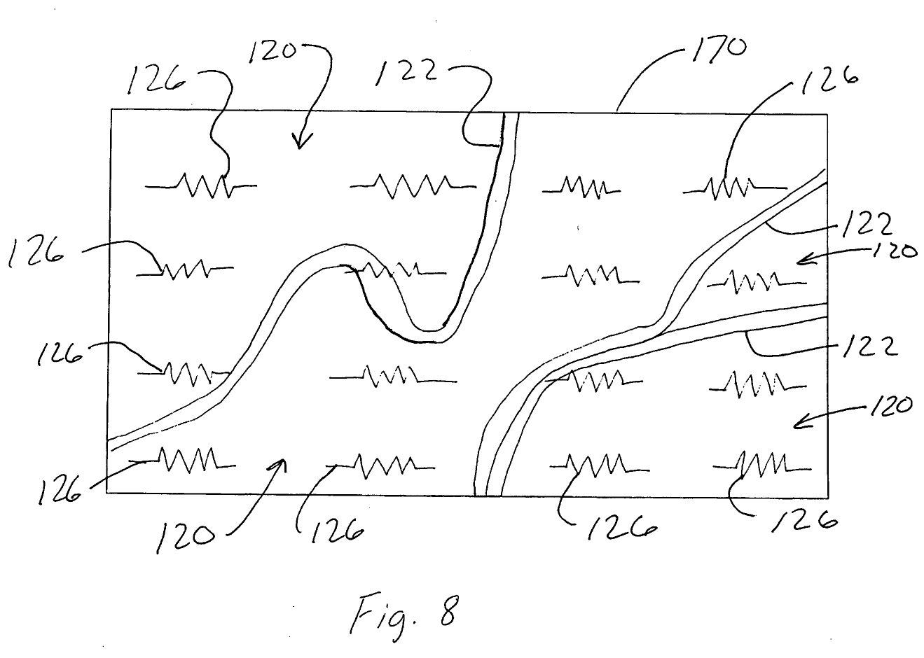

FIGS. 7 and 8 illustrate a second non-limiting example of an apparatus for thermal coding of an artistic work 110. As best seen in FIG. 7, the artistic work 110 is mounted in a box 114. The box includes side panels 113. Stops 138 are mounted to the side panels 113 and are used to locate the artistic work 110 relative to the box 114.

The artistic work has a front side 111 and a rear side opposite the front side. In some embodiments, a layer of conductive material 118 is applied to the rear of the artistic work 110.

A fibrous heating panel 170 is placed in close proximity to the rear side of the artistic work 110. As best seen in FIG. 8, the fibrous heating panel includes an array of heating elements 126. The fibrous heating panel 170 is similar to the fibrous heating panels commonly used in radiant floor heating. The fibrous heating panel 170 is a fibrous mat embedded with resistance heating elements. Optionally, the fibrous heating panel 170 includes shielding to reduce electromagnetic interference.

Barriers 122 are sandwiched between the artistic work 110 and the fibrous heating panel 170. In the embodiment depicted in FIG. 8, the barriers 122 are tubing, such as plastic, rubber, or metal tubing. The barriers 122 are used to create color/temperature zone 120. The barriers 122 thermally isolate one color/temperature zone 120 from the next and help ensure that the appropriate temperature differential between the color/temperature zones 120 is maintained.

A control mechanism is used to selectively connect the heating elements 126 to a power source in order to maintain selected temperatures within the respective color/temperature zones 120. In the embodiment depicted in FIG. 7, the control mechanism includes relays 130 electrically connected to the heating elements 126 of the fibrous heating panel 170. The relays 130 are coordinated to maintain selected temperatures in the respective color/temperature zones 120. As an example, relay 130a may control a first set of heating elements 126, whereas relay 130d may control a second set of heating elements 126. In the depicted embodiment, the relays 130 are timer relays. The relays 130 are connected to a transformer 134. The transformer 134 is connected to a power source. In the depicted embodiments, the transformer 134 is connected to the power source via a plug 136.

### INDUSTRIAL APPLICABILITY

In the examples illustrated, the color-based object that is thermally coded is an artistic work. This represents one significant use for the present invention. These embodiments illustrate a method by which any artistic work can be “translated” by thermal coding for the visually impaired. The method includes separation of the artistic work into any number of color/temperature zones based on the use of color in the work, each color/temperature zone being assigned a desired temperature; thermally insulating each of the color/temperature zones from one another; providing at least one heat source for each of the color/temperature zones, providing at least one temperature sensor with a desired temperature set point for each of the color/temperature zones, controlling each heat source to maintain the temperature of its respective color/temperature zone at the desired temperature.

However, the described method of thermally coding objects has additional applicability wherever it is desirable to represent colors and variations in colors by tactile means. One such example is in the classroom as a teaching aid to the visually impaired to introduce the concept of color.

Other objects, features and advantages of the present invention will be apparent to those skilled in the art. While preferred embodiments of the present invention have been illustrated and described, this has been by way of illustration and the invention should not be limited except as required by the scope of the appended claims and their equivalents.

1. A method of thermally coding an object, the method comprising the steps of:
a. dividing the object into any number of zones based on the use of at least one color in the object;
b. assigning each of said zones a desired temperature;
c. thermally insulating each of said zones from one another;
d. providing at least one heat source for each of said zones;
e. providing at least one temperature sensor with a desired temperature set point for each of said zones; and
f. controlling said at least one heat source to maintain said desired temperature within each of said zones.

2. The method of claim 1, wherein said step of assigning each of said zones a desired temperature further comprises the steps of identifying said at least one color in the object and selecting said desired temperature corresponding to each of said at least one color.

3. The method of claim 1, wherein said step of controlling said at least one heat source to maintain a selected temperature within each of said zones further comprises the step of selectively connecting said at least one heat source to a power source.

4. A method of assembling a thermally coded artistic work, the thermally coded artistic work having a front side and a rear side opposite the front side, the method comprising the steps of:
a. providing a box having a front end portion, a rear end portion, and four side panels;
b. connecting the artistic work to said front end portion of said box;
c. providing a backing plate;
d. mounting a plurality of barriers to said backing plate, said barriers defining at least one perimeter of a temperature zone, and said at least one perimeter corresponding to a shape on the artistic work;
e. mounting at least one heat source to said backing plate and in-between said plurality of barriers;
f. connecting at least one control mechanism to said at least one heat source and to a power source;
g. interweaving insulation between said plurality of barriers; and
h. mounting said backing plate to said rear end portion of said box.

5. The method according to claim 4, further comprising the step of applying a layer of conductive material to the rear side of the artistic work.

6. The method according to claim 4, wherein said box includes an interior and an exterior, and the method further comprising the step of placing a layer of insulation adjacent to said four side panels and along said interior of said box.

7. The method according to claim 4, wherein the step of connecting at least one control mechanism to said at least one heat source and to a power source further comprises the step of mounting at least one temperature sensor in close proximity to the artistic work.

8. The method according to claim 4, wherein the step of connecting at least one control mechanism to said at least one heat source and to a power source further comprises the step of further comprises the step of electrically connecting said at least one heat source to at least one relay.

9. The method according to claim 8, further comprising the steps of electrically connecting said at least one relay to a transformer and electrically connecting said transformer to said power source.

10. An apparatus for thermally coding a color-based object, the apparatus comprising:
a. a frame to adapted to receive the color-based object;
b. a plurality of barriers mounted to said frame, said plurality of barriers defining a perimeter of at least one color/temperature zone, said at least one color/temperature zone corresponding to at least one color of the color-based object;
c. insulation connected to said plurality of barriers and outlining said perimeter;
d. at least one heat source mounted on said frame for heating said at least one color/temperature zone; and
e. at least one control mechanism electrically connected to said at least one heat source and to a power source, said at least one control mechanism adapted to selectively connect said at least one heat source to said power source in order to achieve a desired temperature in each of said at least one color/temperature zone.

11. The apparatus according to claim 10, wherein said at least one control mechanism comprises at least one relay electrically connected to said at least one heat source.

12. The apparatus according to claim 10, wherein said at least one control mechanism comprises at least one temperature sensor located adjacent the object and electrically connected to said at least one heat source, said at least one temperature sensor adapted to sense a temperature within said at least one color/temperature zone.

13. The apparatus according to claim 10, wherein said at least one heat source is embedded in a fibrous heating panel.

14. The apparatus according to claim 10, wherein the color-based object is an artistic work.

15. The apparatus according to claim 14, wherein said artistic work is a two-dimensional painting rendered on a canvas.

16. An apparatus for thermally coding an artistic work having a front side and a rear side opposite the front side, the apparatus comprising:
a. a box, said box having a plurality of side panels and a backing plate, and the artistic work mounted to a front end portion of said box;
b. a plurality of barriers operatively connected to the artistic work, said plurality of barriers defining at least one zone;
c. at least one heat source operatively connected to said box for heating said at least one zone; and
d. at least one control mechanism electrically connected to said at least one heat source and to a power source, said at least one control mechanism adapted to selectively connect said at least one heat source to said power source in order to achieve a desired temperature in each of said at least one color/temperature zone.

17. The apparatus according to claim 16, wherein said at least one heat source is embedded in a fibrous heating panel.

18. The apparatus according to claim 16, further comprising a layer of conductive material applied to the rear side of the artistic work.

19. The apparatus according to claim 16, further comprising stops mounted to said box.

20. The apparatus according to claim 16, wherein said box is made from a material selected from the group consisting of: wood, metal, plastic, and fiberglass.

21. The apparatus according to claim 16, further comprising a layer of insulation attached to said side panels.

22. The apparatus according to claim 16, wherein said plurality of barriers comprises a plurality of supports and insulation mounted on said supports.

23. The apparatus according to claim 16, wherein there is at least one heat source for each zone.

24. The apparatus according to claim 16, wherein said at least one heat source is a light bulb.

25. The apparatus according to claim 16, wherein said at least one heat source is a resistance heating element.

26. The apparatus according to claim 16, further comprising at least one fixture to receive said at least one light source mounted to said box.

27. The apparatus according to claim 16, wherein said at least one control mechanism comprises a relay electrically connected to said at least one heat source.

28. The apparatus according to claim 27, wherein said relay is time controlled.

29. The apparatus according to claim 27, wherein there is at least one relay for each zone.

30. The apparatus according to claim 27, wherein said at least one control mechanism further comprises a transformer electrically connected to said power source.

31. The apparatus according to claim 16, wherein said at least one control mechanism comprises at least one temperature sensor located adjacent the artistic work and electrically connected to said at least one heat source, said at least one temperature sensor adapted to sense a temperature within said at least one zone.

32. The apparatus according to claim 31, wherein there is at least one temperature sensor for each zone.

33. The apparatus according to claim 31, wherein said at least one temperature sensor is a mercury switch.

34. The apparatus according to claim 31, further comprising foil tape to mount said at least one temperature sensor to the artistic work.
